(19) United States
(12) Patent Application Publication
(10) Pub. No.: US 2014/0360295 A1
(43) Pub. Date: Dec. 11, 2014

(54) DRIVE TRANSMISSION SYSTEM AND METHOD FOR MOUNTING SUCH A DRIVE TRANSMISSION SYSTEM

(71) Applicants: Michael HEIDAN, Stuttgart (DE); Hartmut EBERST, Schwaebisch Gmuend (DE)

(72) Inventors: Michael HEIDAN, Stuttgart (DE); Hartmut EBERST, Schwaebisch Gmuend (DE)

(21) Appl. No.: 14/295,671

(22) Filed: Jun. 4, 2014

(30) Foreign Application Priority Data
Jun. 5, 2013 (DE) 10 2013 210 470.7

(51) Int. Cl. F16H 19/06; B60J 7/02

(52) U.S. Cl. CPC F16H 19/0645; B60J 7/02
USPC 74/89.2; 29/428

(57) ABSTRACT

A drive transmission system for a sheet-like structure movable in relation to a vehicle section, with at least one flexible drive cable which can transmit tensile and/or compressive forces, and with at least one stationary dimensionally stable conduit in which the drive cable is laid. The drive cable is guided in a slidably movable manner in a flexible plastic hose which is arranged in the conduit and which is held stationarily in relation to the conduit, the plastic hose having on the inside low sliding friction with respect to the drive cable.

### CROSS REFERENCE TO RELATED APPLICATION

This application claims the priority of the German patent application DE 10 2013 210 470.7 the disclosure of which is hereby incorporated into this application.

### FIELD OF THE INVENTION

The invention relates to a drive transmission system for a sheet-like structure movable in relation to a vehicle section, with at least one flexible drive cable which can transmit tensile and/or compressive forces, and with at least one stationary dimensionally stable conduit in which the drive cable is laid, and also to a method for mounting such a drive transmission system with at least one conduit shaped out of a frame part of the drive transmission system.

### BACKGROUND OF THE INVENTION

Such a drive transmission system is known from DE 44 22 646 C1. The known drive transmission system is provided for driving a movable roof part of a vehicle roof module. The vehicle roof module has a dimensionally stable frame made from sheet metal, in which two conduits for drive cables of the drive transmission system are impressed. The drive cables are driven synchronously via an electric drive unit and serve for displacing the roof part in the longitudinal direction between a position closing the vehicle roof module and a position enabling opening of the vehicle roof module. The drive cables are designed as pitch cables which are also designated as threaded cables. The conduits are formed by the alternating embossing of channel-shaped wall portions to opposite sides of the sheet metal frame. The drive cable is thereby guided between these wall portions and cannot be deflected either upward or downward. During operation, the drive cables knock against the wall portions of the conduit and cause noises which may have a disturbing effect.

DE 20 2005 018 138 U1 shows a further drive transmission system for a movable roof part of a vehicle roof module, in which the drive cables are laid in guide tubes made from plastic, the guide tube being fastened at one end by means of a bracket positioned in the region of a drive unit and at the opposite end thereof to a lateral guide rail for the movable roof part. Clamping elements are provided, distributed over the length of the guide tube, in order to fix the guide tube to a frame of the vehicle roof module.

### SUMMARY OF THE INVENTION

The object of the invention is to provide a drive transmission system and a method for mounting the latter, which allow a simple set-up and low-noise operation.

This object is achieved for the drive transmission system in that the drive cable is guided in a slidably movable manner in a flexible plastic hose which is arranged in the conduit and which is held stationarily in relation to the conduit, the plastic hose having on the inside low sliding friction with respect to the drive cable. By virtue of the solution according to the invention, the plastic hose is integrated as a guide hose in the conduit and encapsulates the drive cable. By the drive cable being guided in the plastic hose, the low-noise operation of the drive transmission system becomes possible. The flexibility of the plastic hose ensures that the plastic hose can be laid even in bend regions of the conduit. The conduit can be configured from alternately interrupted wall portions of a frame part which are shaped out toward opposite sides. Preferably, this frame part is produced from sheet metal and the conduit is laid by pressing the sheet metal. Alternatively, the frame part may also be produced in the manner of a plate from thermoplastic, if appropriate fiber-reinforced. In the case of such a plastic frame part, too, the wall portions of the conduit are shaped in one piece. Moreover, the conduit may comprise rectilinear guide rail portions which are led along on opposite sides of the movable sheet-like structure. The guide rail portions are preferably fastened to the frame part in alignment with the respective conduit of the frame part. The drive transmission system according to the invention is provided especially advantageously for a dimensionally stable sheet-like structure in the form of a movable roof part of a vehicle roof module. The vehicle roof module is installed as a prefabricated and preassembled structural unit in a roof cutout of a vehicle roof of a motor vehicle, in particular of a passenger car. Alternatively, there is provision according to the invention for the drive transmission system to be provided for movable side windows of motor vehicles, a corresponding side window forming the movable sheet-like structure according to the invention. Finally, it is also possible to provide the drive transmission system for a protective device in a vehicle interior, in which the movable sheet-like structure is formed by a flexible sheet-like structure in the form of a trunk cover, of a partition netting or of a shading structure for a transparent side, rear or roof region of the vehicle interior.

In a refinement of the invention, the plastic hose extends at least largely over an entire length of the assigned drive cable. This ensures that the drive cable is encapsulated on its entire length which is effective during the operation of the drive cable, so that virtually no noises arise during the operation of the drive transmission system as result of the sliding of the drive cable against the inner wall of the plastic hose. The low sliding friction between the inner wall of the plastic hose and the drive cable, on the one hand, ensures low-noise functioning of the drive cable. On the other hand, the low sliding friction resistance between the drive cable and the plastic hose enables the drive cable to be operated with low energy demand by an electric drive unit of the drive transmission system.

In a further refinement of the invention, the plastic hose is provided partially with a longitudinal slot, through which a driver element of the drive cable projects laterally outward. The longitudinal slot is provided over the movement travel of the driver element in the plastic hose which the driver element executes when the drive transmission system is in operation. The driver element serves for coupling to the movable sheet-like structure.

In a further refinement of the invention, the plastic hose is provided with supporting profilings which project laterally outward and which are formed in one piece on the plastic hose and cooperate positively with complementary profiling portions of the at least one conduit. The supporting profilings projecting laterally outward serve as an antitwist device for the plastic hose. The supporting profilings may be formed by longitudinal webs or longitudinal edges which extend over part of the length of the plastic hose or over the entire length of the plastic hose. Corresponding supporting profilings may also be formed by virtue of a polygonal design of the outer casing of the plastic hose. The plastic hose is provided inside with a circular cross section in order to ensure good low-friction guidance of the drive cable which likewise has a circular cross section.

In a further refinement of the invention, the plastic hose is produced from polyoxymethylene as a homopolymer or copolymer. This high-molecular thermoplastic may be left natural or be colored. The plastic has the suitable properties for use as a guide hose of a drive cable.

In a further refinement of the invention, the flexible drive cable is designed as a tension- and pressure-transmitting pitch cable with an external coil ply for drive transmission, said pitch cable being sheathed over its entire length in a thin plastic layer. Sheathing of the pitch cable with the plastic layer ensures corrosion-free operation of the pitch cable. This is because, in the pitch cable, the external coil ply is made by the coiled winding of spring wire. Moreover, the sheathing of the entire pitch cable with the thin plastic layer ensures an improvement in the sliding properties with respect to the inner surfaces of the plastic hose which surrounds the pitch cable and which is laid stationarily in the conduit.

In a further refinement of the invention, the plastic layer is composed of polyamide and has a layer thickness which corresponds to between 1% and 5% of a diameter of the pitch cable. Since the plastic layer has small thickness, it fits snugly against the external coil ply, so that the function of the drive cable is not impaired.

In a further refinement of the invention, the conduit has, distributed over its length, wall portions which are alternately open toward one side and toward the opposite side and are of channel-like shape and into which the plastic hose is introduced. The conduit is formed in a dimensionally stable frame part of a vehicle roof module which comprises the drive transmission system.

In a further refinement of the invention, fixing means, which fix the plastic hose positively or in a materially integral manner, are provided in the region of the conduit. Such fixing means are preferably provided only at end regions of the conduit, in order to avoid an inadvertent shift of the plastic hose in the conduit. Preferably, the plastic hose is fixed in relation to the conduit in a materially integral manner by ultrasonic welding. The plastic hose may also be provided on the end face with a welded-on closing collar fixed mechanically in an end component which is held stationarily by fastening means.

As regards the method for mounting a drive transmission system, as described above, with at least one conduit shaped out of a frame part of the drive transmission system, the object on which the invention is based is achieved in that the plastic hose is introduced axially into the conduit and is fixed in the conduit, and in that, thereafter, the drive cable is pushed into the plastic hose on the end face. In a first mounting step, the plastic hose is introduced axially into the conduit from one end face of the latter and is drawn or pushed into the conduit. Thereafter, the plastic hose is fixed against inadvertent shifting or twisting inside the conduit preferably by means of ultrasonic welding. Finally, the drive cable is pushed into the plastic hose on the end face until the drive cable has reached its functional position inside the plastic hose.

In a refinement of the method, after the drive cable has been pushed in, the driver element is fastened to the drive cable in the region of the longitudinal slot of the plastic hose. This refinement is advantageous, since the driver element projecting laterally from the drive cable cannot be pushed axially through the plastic hose serving as a guide hose.

### BRIEF DESCRIPTION OF THE DRAWINGS

Further advantages and features of the invention may be gathered from the claims and from the following description of a preferred exemplary embodiment of the invention which is illustrated by means of the drawings.

FIG. 1 shows a perspective illustration of a detail of a vehicle roof module, the movable roof part of which can be moved by means of an embodiment of a drive transmission system according to the invention,

FIG. 2 shows an enlarged isometric illustration of a detail of the vehicle roof module according to FIG. 1 in the region of the drive transmission system,

FIG. 3 shows the detail according to FIG. 2 in a further-enlarged illustration,

FIG. 4 shows a top view of a subregion of the vehicle roof module according to FIG. 1,

FIG. 5 shows a sectional illustration of the detail according to FIG. 4 along the sectional line V-V in FIG. 4,

FIG. 6 shows a further sectional illustration VI-VI of the subregion according to FIG. 4,

FIG. 7 shows a greatly enlarged cross-sectional illustration of a conduit of the drive transmission system according to FIGS. 1 to 3 with an integrated guide hose and with a drive cable movable in the guide hose,

FIG. 8 shows a longitudinal sectional illustration of a detail of a drive cable according to FIG. 7,

FIG. 9 shows a cross-sectional illustration of a detail of the drive transmission system according to FIG. 1 in the region of a lateral guide,

FIG. 10 shows a diagrammatic cross-sectional illustration of a further subregion of the drive transmission system similar to FIG. 9,

FIG. 11 shows a plastic hose for an embodiment of a drive transmission system according to the invention similar to FIGS. 1 to 4,

FIG. 12 shows the plastic hose according to FIG. 11 fixed on the end face in an end component, and

FIG. 13 shows an enlarged illustration of the end component according to FIG. 12.

### DETAILED DESCRIPTION

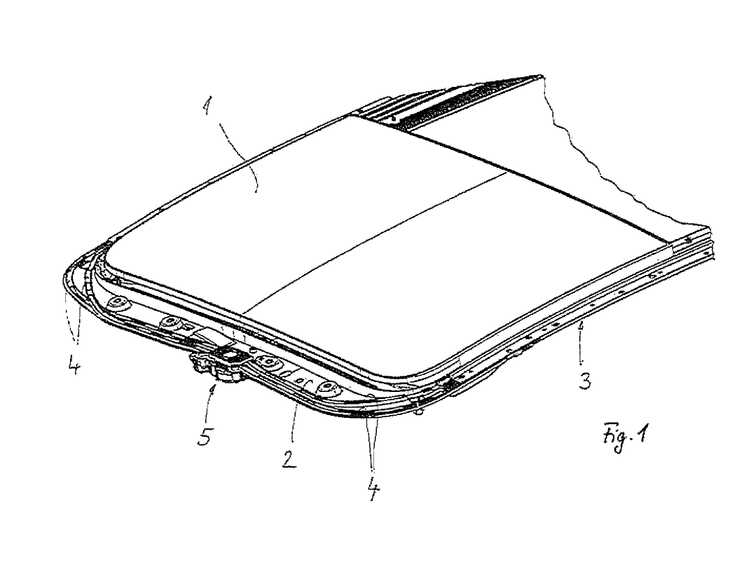

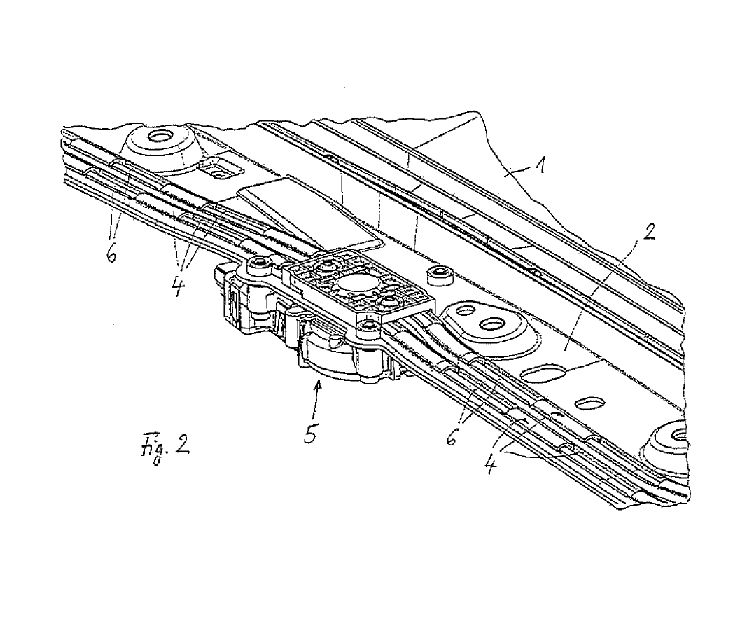

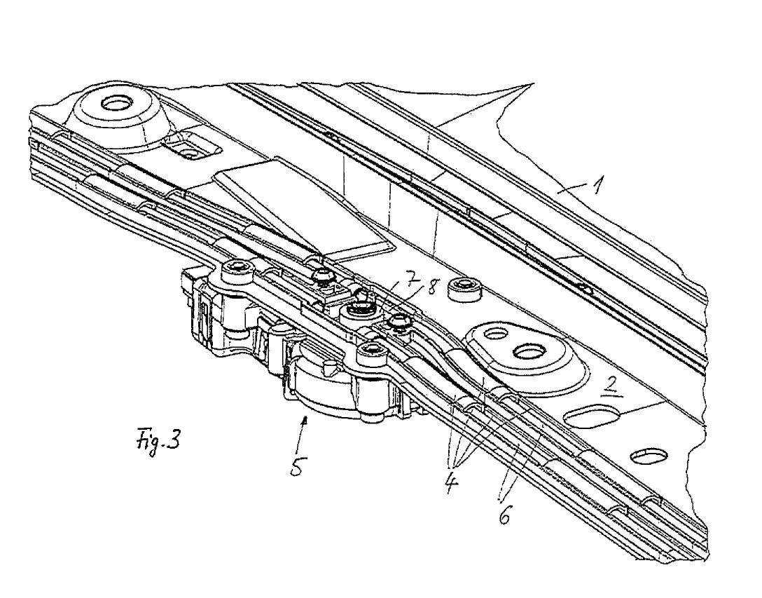

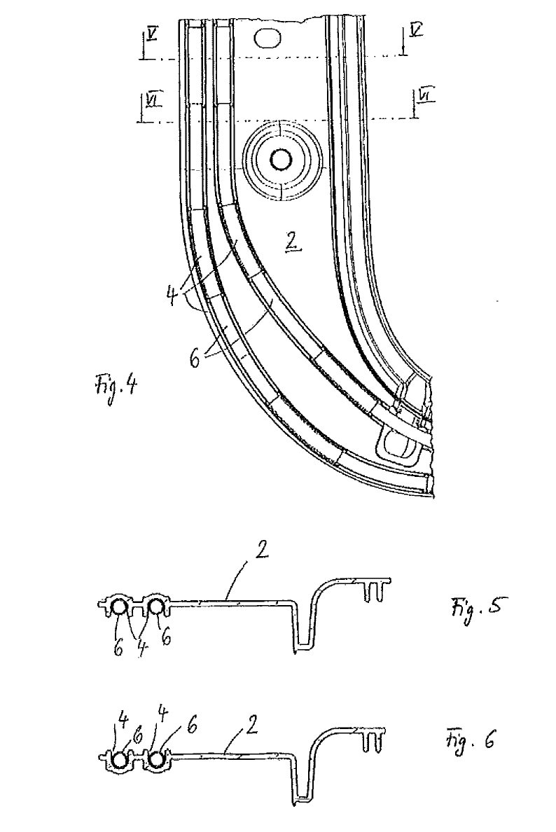

A vehicle roof module according to FIG. 1 is provided for mounting in the region of a roof cutout of a vehicle roof of a passenger car. The vehicle roof module has a movable roof part 1 which is displaceable in the longitudinal direction and which can be displaced in lateral guide rails 3 of a dimensionally stable frame arrangement of the vehicle roof module. The lateral guide rails 3 merge at the front into a dimensionally stable frame part 2 which is configured as a sheet metal structure. In another embodiment of the invention, the frame part 2 is configured as a glassfiber-reinforced plastic component. The front frame part 2 carries an electric drive unit 5 of a drive transmission system which is provided for displacing the movable roof part 1. The electric drive unit 5 is accommodated in a housing fastened to the frame part 2 and has, in addition to an electric motor, a gear and a drive transmission pinion 7 (FIG. 3). The drive transmission pinion 7 drives two drive cables 8 in the form of pitch cables which are synchronously moved contradirectionally to one another. One drive cable 8 extends toward one longitudinal side of the roof part 1. The other drive cable 8 extends toward the opposite longitudinal side of the roof part 1 into the respective guide rail 3. The frame part 2 is provided with two conduits 4 which are formed by wall portions (see FIGS. 3 to 7) alternately impressed upward and downward. In the case of a plastic frame part, the wall portions are shaped in one piece. The conduits continue in the lateral guide rails 3, the conduits 4 being joined in alignment to corresponding conduit portions 4a of the guide rails 3 at front end face regions of the guide rails 3. A plastic hose 6 serving as a guide hose is laid stationarily in each case in the conduits 4, 4a and is composed of polyoxymethylene. The plastic hose 6 is provided with a circular inner cross section and essentially with a circular outer cross section and is coordinated in its outer dimensions with the associated conduit 4 in such a way that the plastic hose 6 can be pushed axially into the conduit and, in the pushed-in functional position, bears, essentially free of play, against the wall portions of the respective conduit 4. In order to avoid an axial shift of the plastic hose 6 inside the respective conduit 4, the plastic hose 6 is connected in a materially integral manner to corresponding wall portions of the conduit 4 by ultrasonic welding and is thereby fixed in the conduit 4. In addition, the plastic hose 6 may be provided with lateral supporting profilings 15 (FIG. 10) which impart an antitwist action within a corresponding conduit 4a, preferably within the guide rail 3, in that the supporting profilings 15 are supported positively at marginal regions of a longitudinal groove of the guide rail 3 or conduit 4a.

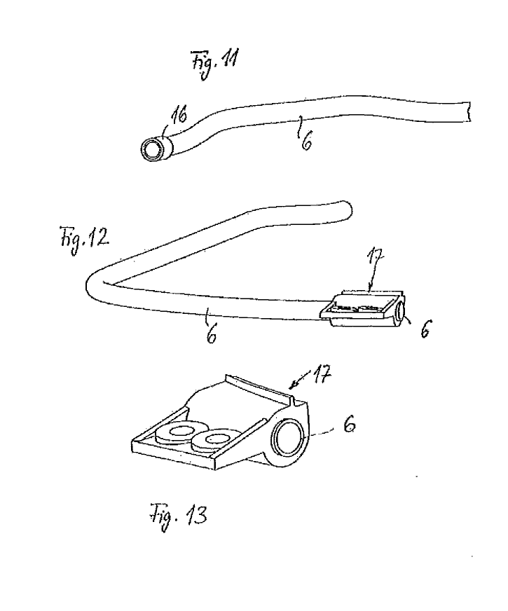

Alternatively or additionally, the plastic hose 6 may be provided at at least one end face region with a closing collar 16 which is configured as a dimensionally stable sleeve welded on ultrasonically. The closing collar is positively held axially in the conduit 4. Additionally or alternatively, the closing collar 16 may be fixed in the conduit 4 by welding or adhesive bonding. In the embodiment according to FIGS. 12 and 13, the plastic hose 6 is drawn into a dimensionally stable end component 17 made from plastic and is connected to this by ultrasonic welding. The end component 17 is connected to the frame part 2 in the region of the conduit 4 by screwing or riveting. The plastic hose 6 according to FIGS. 12 and 13 is provided in the region of the working side of the respective drive cable, that is to say in the region of the side on which the drive cable actively drives the corresponding sheet-like structure. By contrast, the plastic hose 6 according to FIG. 11 is arranged on the stowage side on which that part of the drive cable is accommodated which, depending on the position of the drive cable, is not required during corresponding drive transmission. The end component 17 is fixed at the region of transition of the frame part 2 to the guide rail 3. The frame part 2 therefore carries for each drive cable, on one side of the drive unit 5, a plastic hose 6 defining the working side and, on the opposite side, a plastic hose 6 forming the stowage side, which plastic hoses are naturally in alignment with one another in order to accommodate the common drive cable 8. Conversely, correspondingly, for the other drive cable 8, the plastic hose 6 forming the drive side is on the opposite side and the plastic hose 6 forming the stowage side is opposite and correspondingly in alignment.

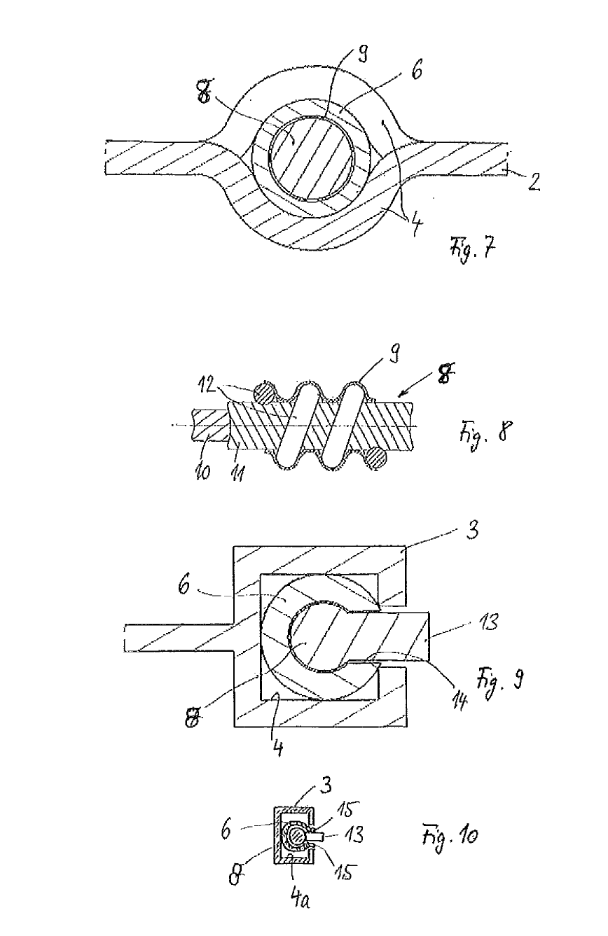

As can be seen from FIG. 9, moreover, the plastic hose 6 is provided over some regions of its length with at least one longitudinal slot 14, through which a driver element 13 of the drive cable 8 can project laterally outward. The driver element 13 is provided for coupling to corresponding guide elements of the movable roof part 1. The plastic hose 6 is laid through the conduit portions 4, 4a of the guide rails 3. In other exemplary embodiments of the invention, the plastic hose 6 ends in the corresponding conduit of the frame part 2.

The drive cable 8 is provided (FIG. 8) as a pitch cable with a central core 10, with a sleeve-shaped middle ply 11 and with a coil ply 12 surrounding the middle ply 11 and made from coiled spring wire. In addition, an outer contour of the drive cable 8 is sheathed in a thin plastic layer 9 which is composed of polyamide and has a layer thickness which corresponds to between 1% and 5% of a diameter of the drive cable 8. For this purpose, the diameter of the drive cable is measured in the region of the coil ply 12 as the outside diameter of the drive cable 8.

To mount the drive transmission system, after the completion of the conduit 4 and the connection of the frame part 2 to the guide rails 3, the plastic hose 6 for the respective conduit 4 is pushed or drawn axially into the respective conduit 4, starting from the region at which the bracket is fastened to the electric drive unit 5. Thereafter, the drive cable 8 is introduced into the respective plastic hose 6 from one axial end face of the respective plastic hose 6. Preferably, starting from the region of the electric drive unit 5, each conduit 4 is provided toward each of the opposite sides of the roof part 1 with a drawn-in or pushed-in plastic hose, so that there is no plastic hose provided in the region of the electric drive unit 5 subsequently to be mounted and therefore in the region of the drive pinion 7. The end faces of the opposite plastic hoses 6 of a conduit 4 in each case thus issue, opposite to one another, in the region of the drive pinion 7. After the drive cable 8 has been pushed or drawn through axially, a corresponding driver element 13 is directly fastened laterally to the drive cable 8 from outside in the region of a corresponding longitudinal slot 14 of the hose 6.

1. A drive transmission system for a sheet-like structure movable in relation to a vehicle section, with at least one flexible drive cable which can transmit tensile and/or compressive forces, and with at least one stationary dimensionally stable conduit in which the drive cable is laid, wherein the drive cable is guided in a slidably movable manner in a flexible plastic hose which is arranged in the conduit and which is held stationarily in relation to the conduit, the plastic hose having on the inside low sliding friction with respect to the drive cable.

2. The drive transmission system as claimed in claim 1, wherein the plastic hose extends at least largely over an entire length of the assigned drive cable.

3. The drive transmission system as claimed in claim 1, wherein the plastic hose is provided partially with a longitudinal slot, through which a driver element of the drive cable projects laterally outward.

4. The drive transmission system as claimed in claim 1, wherein the plastic hose is provided with supporting profilings which project laterally outward and which are formed in one piece on the plastic hose and cooperate positively with complementary profiling portions of the at least one conduit.

5. The drive transmission system as claimed in claim 1, wherein the plastic hose is produced from polyoxymethylene as a homopolymer or copolymer.

6. The drive transmission system as claimed in claim 1, wherein the flexible drive cable is designed as a tension- and pressure-transmitting pitch cable with an external coil ply for drive transmission, said pitch cable being sheathed over its entire length in a thin plastic layer.

7. The drive transmission system as claimed in claim 6, wherein the plastic layer is composed of polyamide and has a layer thickness which corresponds to between 1% and 5% of a diameter of the pitch cable.

8. The drive transmission system as claimed in claim 1, wherein the conduit has, distributed over its length, wall portions which are alternately open toward one side and toward the opposite side and are of channel-like shape and into which the plastic hose is introduced.

9. The drive transmission system as claimed in claim 1, wherein fixing means, which fix the plastic hose positively or in a materially integral manner, are provided in the region of the conduit.

10. A method for mounting a drive transmission system as claimed in claim 1, with at least one conduit shaped out of a frame part of the drive transmission system, wherein the plastic hose is introduced axially into the conduit and is fixed in the conduit, and wherein, thereafter, the drive cable is pushed into the plastic hose on the end face.

11. The method as claimed in claim 10, wherein, after the drive cable has been pushed in, the driver element is fastened to the drive cable in the region of the longitudinal slot of the plastic hose.
